(19) United States
(12) Patent Application Publication
(10) Pub. No.: US 2021/0365915 A1
(43) Pub. Date: Nov. 25, 2021

(54) Self-serve product dispenser system with associated dynamically modifiable tiered menu

(71) Applicant: Automated Vendtech LLC, Oakland, CA (US)

(72) Inventors: Martin A. Kaufman, Fairfax, CA (US); Ronald Christensen, SR., Walnut Creek, CA (US)

(21) Appl. No.: 15/932,807

(22) Filed: Apr. 27, 2018

Related U.S. Application Data
(60) Provisional application No. 62/492,162, filed on Apr. 29, 2017.

(51) Int. Cl. G06Q 20/20; G06Q 30/06; G07F 17/00

(52) U.S. Cl. CPC G06Q 20/203; G07F 17/0014; G06Q 30/0641

(57) ABSTRACT

A self-serve product dispenser system includes a user-interactable tiered menu that is dynamically modifiable in realtime to display available products at current price. The menu may be displayed proximate to the product dispenser, or displayed remotely, e.g., on a user's smart device. Preferably the menu is displayed on a touch screen to facilitate user touch-interaction with images of available products, which interaction advances to a new menu tier with more detailed product information. The user can touch-select payment mode and can make secure payment in a variety of ways, including remotely. Upon confirmed payment, products are dispensed directly from the product dispenser, and associated inventory is debited by the quantity of dispensed products. However, the product dispenser may act as a virtual locker should the user elect to select and pay for products but defer secure pick-up from the dispenser.

### PRIORITY CLAIM

Priority is claimed from applicants' pending U.S. Provisional patent application entitled Self-Serve Product Dispenser With Associated Dynamically Modifiable Tiered Menu, filed 29 Apr. 2017, provisional application Ser. No. 62/492,162.

### FIELD OF THE INVENTION

The invention relates to self-operated automated dispensers of products including consumable products. More specifically, the invention relates to a product dispenser (or vending machine or kiosk) that can be network coupled to remote server(s) to provide a qualified user with an associated tiered menu display of products. User interaction with the menu allows product selection and payment, and disbursement of products from the dispenser to the user. In some aspects, the associated menu may be displayed and accessed remotely to enable remote product selection, ordering, and payment by the user. After such remote access, the user may then go to the dispenser, self-identify using PIN ID data or the like uniquely established securely at time of remote payment. This PIN ID data allows the user to access the dispenser, input the PIN ID data, whereupon the selected and paid for products are substantially simultaneously dispensed. In the interim, the dispenser has functioned as a virtual locker for the user's purchased product, until pick-up. A preferably distributed computing system used by the dispenser can customize the tiered menu display to the user, to promote more and rapid sales of products. The computing system also tracks product inventory in realtime and can gather data, including user purchase history, near expiration date of products to be sold, and the like.

### BACKGROUND OF THE INVENTION

Self-service product dispensers are known in the art, e.g., cigarette machines, soft drink machines. The menu in such dispensers is often a sample or image of the product, e.g., packs of various brands of cigarettes, pictures of various brands of sodas, etc. The product price is stated on the vending machine. Upon the user's pushing a selection button and inserting money, the selected product is dispensed. However, such dispensers have a static menu such that products and/or prices are not readily modifiable, and certainly are not readily modified remotely, or dynamically. Further, the specific information from a just completed transaction is generally not communicated such that inventory control knows that so many units of a specific product have just been sold and dispensed.

Some vending type machines employ dynamic menus with which a user can interact to customize a purchase, e.g., buying a book online, buying a transportation ticket, where at the conclusion of the transaction the vending machine provide an appropriate ticket for the user.

However, such vending machines dispense products for which there may be no requirement that only qualified users are permitted to make purchases. Some products may not be legally dispensed to minors, other products may only be dispensed to qualified users possessing a medical prescription, and so forth. Thus, there is a need for a secure automated product dispenser having an associated user-interactable menu showing products, product details, and offering modes of payment for selected products. Further, such menu should preferably be remotely and dynamically modifiable to reflect current product inventory and price. In applications where at least some products are date-sensitive, prior art vending machines cannot intelligently act to promote sale of such products before their expiration date, e.g., by price reduction, more prominent display, etc. Prior art vending machines do not carry out a locker function such that the user can select and pay for products but choose to defer picking-up such products from the vending machine. In many instances, the products are temperature and humidity sensitive, yet many prior art vending machines do not intelligently protect the storage environment within the machine. Further, in many instances the monetary value of the vending machine and the products within may be quite valuable, yet prior art vending machines lack intelligent means to detect and combat attempted theft and actual theft of the goods and perhaps of the entire vending machine. What is needed is an intelligent product dispenser that provides these functions, missing in the prior art vending machines.

The present invention provides such a method and system for securely dispensing products.

### SUMMARY OF THE PRESENT INVENTION

The present invention provides a self-serve product dispenser (also referred to herein as a vending machine or kiosk) with a distributed computing system and user-interactable associated tiered menu display. In some applications one or more dispensers may be disposed in a secure area, access to which is given only to qualified users. Upon being granted access, a user can use the vending machine to select and pay for menu displayed products, which may then be dispensed by the dispenser to the user. In other embodiments, a qualified user using a smart device app may select and pay for products remotely. Such remote access involves a qualified user first accessing a secure website controlled by the owner or manager of the dispensing system. Such access preferably is carried out with a user's smart device that executes an application (app) provided by the owner or manager of the dispensing system. Online at the website, the remote user can select a conveniently located dispenser and can peruse a user-interactable associated tiered menu display to examine, select and pay for selected products. Payment can be via commonly practiced payment methods, e.g., credit or debit card, a voucher coupon, bitcoin, or the like. Upon remote payment and payment acceptance, the web app will issue a PIN ID to the user that is unique to this transaction. The PIN ID preferably includes data that identifies the user, the date, the specific items purchased and their prices. The user may go immediately to the location of the selected dispenser, or may wait, perhaps days, during which time the selected dispenser acts as a virtual locker for the user and the selected and paid for products. The user will eventually go to the location of the chosen dispenser. Depending upon the relevant security measures that may be in place relevant to the purchased products, the user may have to first identify himself/herself to security, at the dispenser location, as a qualified user, before being granted access to the dispenser. Upon accessing the dispenser, the user will input or otherwise present the PIN ID data to the dispenser, whereupon the previously selected and paid-for products are dispensed by the dispenser to the user. Preferably multiple users may use such remote access to the same to different vending machines.

Regardless of whether viewed on a display at the dispenser location or viewed remotely, the associated menu is dynamically modifiable such that the menu presentation of products available from the dispenser is always up to date, and always displays current product prices. As products are dispensed, realtime feedback between the dispenser and a product-database associated with the preferably distributed computing system, perhaps in a server including perhaps a cloud-based server, ensures that products displayed in the menu are indeed instantly available inventory. Out-of-stock products are automatically removed from menu display, or a “temporarily out stock” sign may be displayed. The computer system can alert personal at the location of the dispenser to refill this product at this time as a user wishes to make a purchase. Further, price of displayed products is always current and may be modified remotely. As noted, if qualifying restrictions exist as to product purchase, access to the dispenser is protected such that users may first have to present vetted qualifying documentation to personnel at the dispenser location, before access to the dispenser is permitted. In other embodiments, the user may approach the dispenser directly and establish authorization by scanning or otherwise presenting an ID card or the like, previously issued to the user by the owner or manager of the dispensing system.

In some embodiments the associated menu is presented on a preferably touch screen display that is physically part of the automated product dispenser or at least in viewing proximity. A user at the dispenser touches the menu Home display to advance to a next menu tier that displays various products available for immediate selection, purchase, and dispensing from the product dispenser. Preferably the menu presents user-selectable tiers of selections and options. If a first menu display of products uninteresting, the touchscreen display menu enables the user to bring up further displays of products. Initial product displays include a matrix-appearing array of sub-displays containing product photographs or videos, product names, and unit prices. If a product is of interest, the user simply touches the product image, which brings up a further menu tier offering a larger image display of the product and more detailed product explanatory text.

The user is free to move backwards or forwards in the menu tier. Eventually if products are selected for purchase, the menu will display a list of the user-selected products, price totals, and will offer the user modes of payment, e.g., cash or credit. The user can simply touch the displayed menu screen to select a mode of payment. The automated dispenser preferably includes a mechanism to receive and count inserted cash, and/or a mechanism to read, verify, and process a user-swiped credit or debit card. In some embodiments the automated dispenser includes a near field communication reader to interact with a user's smartphone or the like for automatic contactless payment for selected products via the smartphone. A computer system within the dispenser communicates in realtime with a system inventory-database such that the number of purchased products is automatically debited from inventory.

In some embodiments, the associated menu is displayed remotely from the automated dispenser on a user's electronic device such as a smartphone, PDA, computer or the like. The user may execute a software application (or app) on the electronic device to view the same up-to-date menu selection of products and prices as would be viewed on a menu displayed on the automated dispenser. Using the electronic device, the user can view the menu display of products at leisure, make selection, and authorize credit card payment from home or other location remote from the dispenser. The electronic device communicates wirelessly, e.g., via the internet, with the system-database associated with the dispenser. The app can create and display on the user's device a PIN uniquely identifying the just-completed transaction. When the user visits the automated dispenser, the user can input the PIN or present an image of the PIN, perhaps as a barcode on a smart device display, whereupon the pre-selected and paid for products are delivered from the dispenser chute, substantially simultaneously.

Embodiments of the present invention preferably include self-regulating internal temperature and humidity climate control. The contents of the present invention may be valuable as is the dispenser itself. Embodiments of the invention preferably include sensors to detect potential breaking into the dispenser, and at least one battery-operated anti-theft system that can warn of potential break-into or potential theft of the entire dispenser. Embodiments preferably include an internal battery-operated GPS system to send coordinate location data via the Internet providing the current location of the dispenser. If the dispenser is moved or taken away, its location can be tracked via GPS data. Preferably the dispenser includes a battery-operated internal acoustic signaler that can be trigged wireless, to acoustically pinpoint the location of a stolen, relocated dispenser.

It will be appreciated that embodiments of the invention preferably present a small footprint within a retail establishment where floor space is very valuable, and can provide a qualified user-operating vending machine on a 24/7 basis, without the cost of a check-out person, without requiring the user to wait in long customer lines, while preserving user privacy vis-à-vis other users in the room containing the vending machine concerning the user's purchase. Inventory of products within the vending machine and immediately available to management for restocking the vending machine is maintained in realtime. User purchase histories enable the vending machine menu to suggest products, and can enable management to more intelligently stock and sell products. Products approaching their expiration date may be discounted to enhance probability of sales. Potential correlation of product placement within the displayed menu may result in a more intelligent stacking of products, e.g., more expensive products displayed in a region of the menu where they are more likely to sell.

Other features and advantages of the invention will appear from the following description in which the preferred embodiments have been set forth in detail, in conjunction with their accompanying drawings.

### BRIEF DESCRIPTION OF THE DRAWINGS

FIG. 1 depicts an exemplary automated product dispenser system, according to embodiments of the present invention;

FIG. 2 depicts an exemplary further tier of a menu displaying a first array of selectable products that may be purchased and dispensed from an associated automated product dispenser, according to embodiments of the present invention; and

FIG. 3 depicts an exemplary further tier of a menu displaying details for a product selected by a user from the menu of FIG. 2, according to embodiments of the present invention;

FIG. 4 depicts an exemplary further tier of a menu summarizing purchase price for all products selected from previous use of menu tiers such as shown in FIG. 2, and offering payment options, according to embodiments of the present invention;

FIG. 5A depicts an exemplary further menu tier displaying cash payment instructions to purchase products selected by a user electing to pay cash, according to embodiments of the present invention;

FIG. 5B depicts an exemplary further menu tier displaying credit card or debit card or coupon payment instructions to a user electing to pay using one of these methods, according to embodiments of the present invention;

FIG. 6 is a simplified flow diagram showing exemplary method steps carried out by a product dispenser system, according to embodiments of the present invention; and

FIG. 7 depicts use of a remotely situated electronic smart device displaying menus associated with a network linkable product dispenser, for pre-ordering and pre-paying for products to be dispensed by a selected product dispenser, according to embodiments of the present invention.

### DETAILED DESCRIPTION OF THE PREFERRED EMBODIMENTS

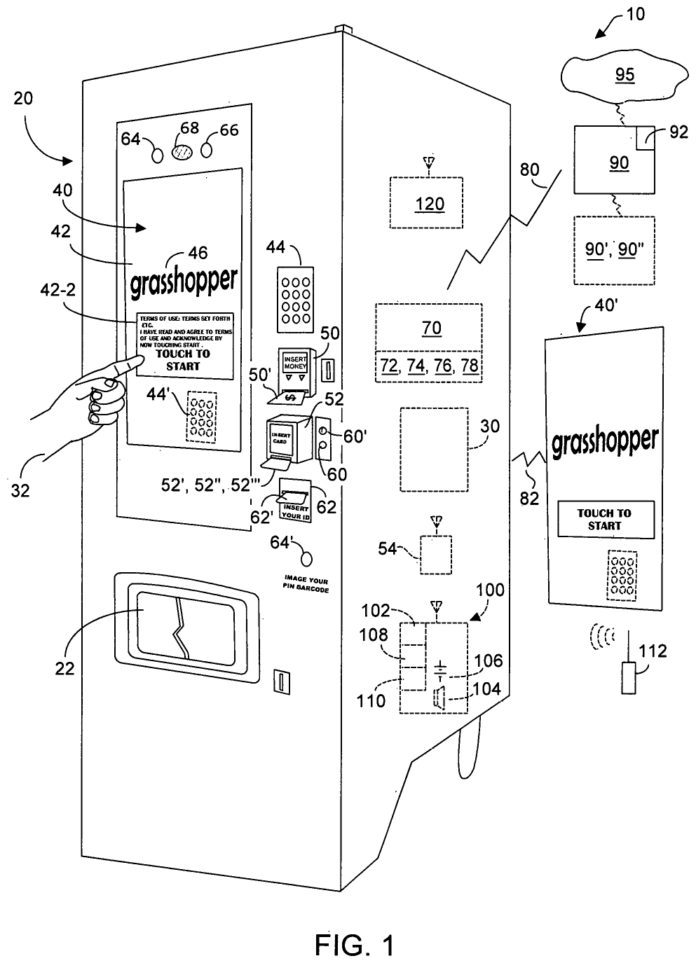

FIG. 1 depicts an exemplary self-serve product dispenser system 10 as including a vending machine dispenser 20 that contains various dispensable products 30 that may be selected by a user 32 who interacts with a preferably touch screen preferably high resolution color display 40 that can present a user-interactable menu 42. Only after secure identification of user 32 is made, and payment is made, as described herein, will the products 30 be dispensed via chute 22. In many applications, dispenser 20 will contain products 30 that may legally only be dispensed to users holding a valid prescription, prescriptive medication, perhaps prescriptive cannabis, for example. In other applications, products 30 may only be legally dispensed to users of legal age, or perhaps there may be quantity limits that may be sold to a single user within a certain time limit, e.g., 1 oz. of product per 24 hours.

Thus, in many applications one or more dispensers 20 may be located in an area, perhaps a store, where access to the area containing the dispensers is secure. By this it is meant that only users able to demonstrate their qualification to access and use a dispenser to purchase products may gain access to the dispenser(s). In some instances the users may possess ID cards, perhaps issued by the owner or manager of the dispenser, demonstrating their qualification. They may have to present this card to a security person guarding access to the dispenser area. In some installations, the user ID card may physically provide access to the dispenser area. In other instances, the would-be user may have to present documents to a security person, which documents establish the user's qualifications, before access is granted. But once controlled access is gained to the dispenser area, the dispenser enables a qualified user to select products and pay for their purchase in realtime, and to instantly receive the products. As such, the dispenser may provide a rapid transaction time, 24/7 point of sale (POS) in which no check-out personnel are required, no waiting in customer lines are required. These aspects of the present invention benefit the user and can maximize profit to the owner or manager of the dispenser.

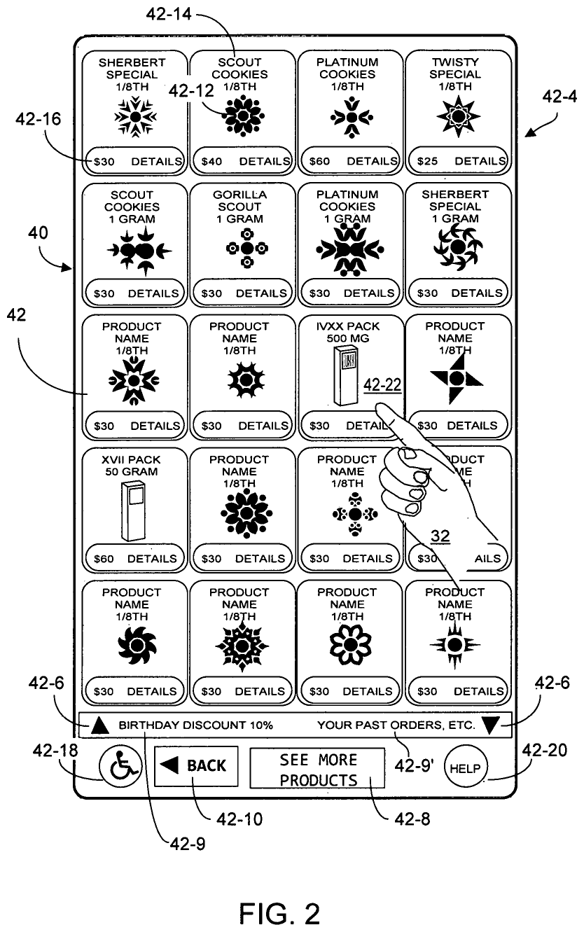

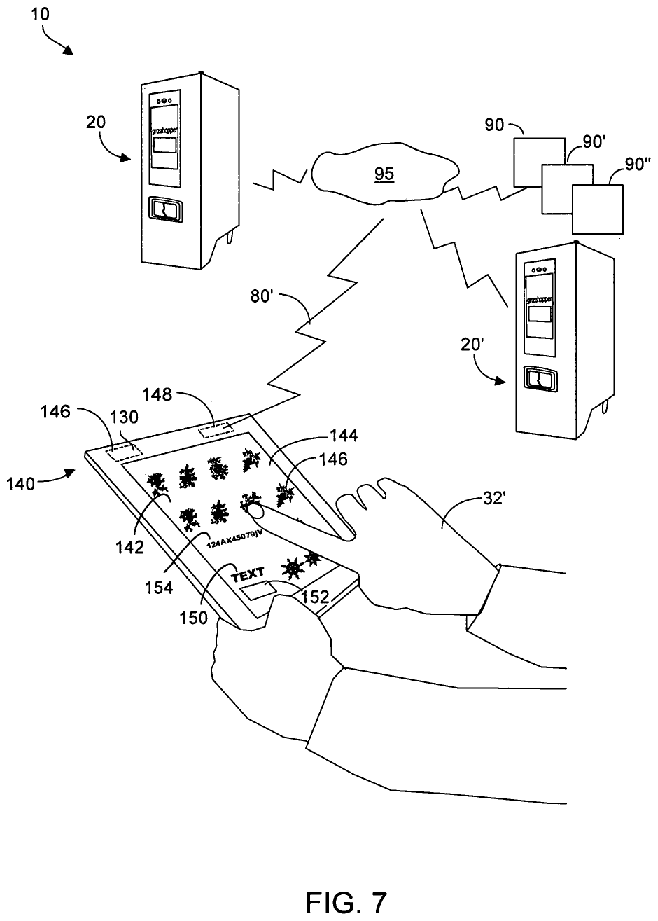

Referring still to FIG. 1, dispenser 20 may also include keys 44 to enable a user whose has qualified to access the dispenser area to input information, perhaps a PIN. However menu 42 could of course include a display of a virtual keypad or virtual keyboard, e.g., 44′, for such user input. Screen 40 may also display advertising, perhaps a company logo 46 or relevant advertising video. If this is a repeater user, the logo or video may be tailored to this user, perhaps suggesting new products based on past history of the user, or based upon knowledge of the user's demographics, e.g., sex, residence area, age, among other factors. The user can request and see on the display a history of past purchases made by the user. As will be described with respect to FIGS. 2-4, 5A and 5B, once the user finalizes menu selections, payment can be made at dispenser 20, for example by inserting cash 50′ into money reader 50, or a credit/debit card 52′ into card reader 52. In some embodiments, card reader 52 can also accept payment from a voucher card 52″, e.g., issued as a credit refund by the owner or manager of vending machine 20, or issued as a reward for referring another user to system 10. Preferably system 10 includes a near field communication system 54, enabling a user to pay for a transaction using a smartphone, tablet, watch or the like that is brought into proximity with dispenser 20. Embodiments of the present invention may include at least one user biometric identification system 60, 60′ to limit secure use of dispenser 20 to authorized users 32. These and other biometric identifications systems work cooperative with computer system 70 and/or remotely located system 90, perhaps a server system, which remote system may in fact be cloud-based; see FIG. 7. ‘For example, a fingerprint sensor 60 and/or a finger vein sensor 60’ can enhance transaction security by selling and dispensing products 30 only to authorized users 32. For example, user 32 presses a finger against fingerprint sensor 60, and/or inserts a finger into vein sensor 60′ to demonstrate entitlement to access and use dispenser 20. Other biometric information may include user facial and/or voice identity, described later herein.

As shown in FIG. 1, dispenser 20 preferably includes a user ID scanner 62 that can read a user input ID card 62′ that identifies the user as qualified to access and use the dispenser to purchase merchandise. In some applications, ID card 62′ might be issued by the owner or manager of dispenser 20, perhaps a pharmacy or a licensed dispensary of goods, cannabis for example. In such case, before ID card 62′ is given to user 32, the user's physician will have satisfied the dispenser owner or manager that the user requires any of products 30 that can be dispensed, and is of legal age. ID card 62′ may include without limitation and or all of a photograph of the user's face, a copy of the user's fingerprint, perhaps a stored voice file of the user. In some instances where age is a sole criterion for access to dispenser 20, ID card 62′ may be a government issued document, perhaps a driver's license with the user's name, address, photograph, and date of birth, perhaps a social security card.

System. 10 preferably includes a computer system 70, a portion of whose memory 74 can store previously gathered user 32 data including fingerprint and/or finger vein data. In some embodiments, computer system 70 is distributed, with some decision making functions being executed by remote servers, e.g., 90, that may be located in the cloud; see FIG. 7. As described later herein, computer system 70 can communicate, wirelessly or otherwise, via link 80 to a remote master system 90 that preferable includes a database 92 that includes data for users, and realtime inventory of products, both within dispenser 20 and available for rapidly restocking dispenser 20. In some embodiments, master system 90 may communicate via cable or wirelessly with other remote systems, denoted 90′, 90″. For example system 90′ may be a regional system, and perhaps system 90″ is a nationwide POS type system. Communication to and from system 90, to and from systems 90′, 90″ may be in a variety of formats including MDB and DEX.

System 90 preferably is compatible with commonly used POS (point of sale) protocol, e.g., that adopted by MJ Freeway, Biotrack, and Green Bits, among others. Such POS systems are the backbone to most retail businesses in the United States. To the extent a given system 90 may not already provide such function, the more sophisticated of such POS systems can provide backend product inventory management modules. In applications where dispenser 20 may be used to sell and dispense cannabis in jurisdictions where such sales are legal, California, for example, the cannabis industry is mandated to have complete integration into the. California state-wide Metrc system, a seed to sale tracking system for the cannabis industry within the state of California. The Metrc system can track all aspects of cannabis, a controlled substance, literally from seed to retail sale, including sale via dispenser 20. Software routines 76 within system 70 preferably are implemented using APIs such that sets of subroutine definitions, protocols, and tools for building application software are integrated to be interface-compatible and compliant with relevant industry standards, including for example MJ Freeway, a company whose software systems and protocols are currently used by over a thousand legal dispensaries. Thus system 90 software, which as noted may be cloud-based, will be legally compliant with MF Freeway standards. As such, dispenser 20 will not violate relevant State or Federal regulations relating to sales of products containing cannabis. Such regulations may include limit on quantity of dosage of products sold to a single user within a certain time period, perhaps a day, a week, etc. System 10 is an integrated networkable system and can track and store in persistent memory what products are sold to which users by which dispenser, and when. Thus these protocol and assurance precautions present in system 10 ensures a user attempting to purchase products whose sale to this user would violate a relevant legal standard will not be permitted to consummate the sale. Display 40 may now present explanatory text on menu 42 advising that sales history reflects the user has purchased so many grams of this product within the last day or days, and that a further sale now would violate relevant law and cannot proceed. An advantage of the networked aspect of system 10 and of its distributed computing capability, see 160, 90, 90′, 90″ etc., FIG. 7, is that relevant knowledge for all users is available at all dispenser locations, and is available for all remote accesses to the system, including via a remote smart device 140. Of course relevant purchase limits may apply to products unrelated to cannabis.

In some embodiments, previously gathered user data including fingerprint and/or finger vein data is stored in databank 92. Only after user identity and thus right to access dispenser 20 is confirmed and user payment using cash, credit card, debit card, or remote field payment is confirmed, will the user selected products be dispensed to the user via chute 22. The inner portion of chute 22 preferably is padded to avoid breaking or damaging dispensed products 30 or their containers.

As further shown in FIG. 1, embodiments of dispenser 20 can include at least one of a camera 64 that can image the face of a user 32 in proximity to the dispenser. In some embodiments, one form of security may include comparing a camera 64-captured image of user 32 attempting to use dispenser 20 against a previously captured image of the known user 32, which image was securely captured, perhaps by the owner of dispenser 20, and stored, e.g., in memory 74 and/or memory associated with remote database 90. A second camera 64′, preferably disposed lower on dispenser 20, may be used to image and thus enter a user's PIN or other barcoded data that a user can present as a print-out and as an image on a smart device, perhaps a smartphone display. Dispenser 20 may include a microphone 66 to detect audible sounds made in proximity to the dispenser, perhaps a user stating aloud, “My name is John Smith”, which sound can be compared against a previously captured sound file of the known user 32, which sound file can be stored in memory 74 and/or memory associated with remote database system 90. Use of such previously captured image and/or sound files can augment security such that only qualified users are given access to dispenser 20, perhaps in embodiments in which dispenser 20 is located within a pharmacy, or an authorized dispensary of controlled products, perhaps prescription medications, medicinal cannabis, or general cannabis. As further shown in FIG. 1, dispenser 20 may include a speaker 68 or the like to annunciate sounds, perhaps computer 70 issued instructions or questions to a user 32 who has stood in close proximity to but has not yet after several minutes interacted with the dispenser. An exemplary instruction might be, “Please touch the screen to begin interaction with the dispenser.” Speaker 68 could also issue alarm sounds if internal anti-theft system 100 detects a breaking into of dispenser 20 is occurring. (In such instance, anti-theft system 100 preferably also issues silent and wireless warnings to remote database system 90 among other recipients, e.g., dispensary owner, security, etc.

It is understood that within dispenser 20 there are servos and motors and the like that cause hoppers containing products including selected and purchased products to be dispensed via chute 22. These mechanical mechanisms are well known in the art and need not be depicted in the figures or described in further detail herein. An exemplary embodiment of dispenser 20 may include perhaps 30 each of 36 different bins (able to hold 36 different products or perhaps a very popular product may be presented in two or more bins). Thus in this exemplary configuration, 30 units of a particular product could be dispensed before it is necessary to refill these bins, or at least remove the depleted product from menu 42.

Dispenser 20 may hold several thousands of dollars' worth of products and in some embodiments system 10 includes a protective internal anti-tampering anti-theft system 100. Protective system 100 includes a vibration sensor system 102 that can detect if someone is rocking the dispenser, perhaps in an attempt to break into the dispenser. Upon detecting rocking vibrations, system 102 can cause an internal speaker 104 and/or speaker 68 to emit a loud sound to deter the potential thief. System 102 can also wirelessly alert system 90 and thus alert the owner or manager of dispenser 20 as to the potential vandalism or theft. An internal speaker 104 is desired in the event a potential thief disables visible speaker 68. In addition, camera 64 can photograph the person(s) rocking the dispenser, and optionally system 102 can cause display 40 to turn-off while vibrations are occurring.

It is also possible that a thief might attempt to steal the entire dispenser, perhaps by breaking through a wall in the area containing the dispenser, and hauling it and its valuable contents away. Dispenser 20 normally is coupled to a source of AC operating power, e.g., 117 VAC or perhaps 240 VAC. Supplementary to AC power, protective system 100 is operable from a preferably large mAh capacity rechargeable battery 106, which is coupled to the AC power source for dispenser 20, for on-going recharging. Battery 106 preferably can maintain power to protective system 100 for days, if not for weeks. Such battery operation capability is desired in case a thief steals the dispenser, during which theft presumably no AC power source would be available. Anti-theft system 100 preferably includes a geo-fencing system 108 that in realtime knows the reference (longitude, latitude) GPS coordinates for dispenser 20 at its normal position, e.g., perhaps in a store. System 108 in realtime compares the reference (longitude, latitude) coordinates against any substantial change in position coordinates, which substantial change indicates a repositioning of dispenser 20, and possibly its removal and theft. Geo-fencing system 108 can wirelessly, e.g., RF, WiFi, Bluetooth, etc., broadcast dispenser 20 location coordinates, including a warning concerning a substantial coordinate change, through an antenna, e.g., to system 90, and thus to the owner or manager of dispenser 20. Upon being alerted to the unexpected positional change of the dispenser, the owner or manager of dispenser 20 can immediately summon authorities to accompany the owner/manager to the system 100-broadcast new coordinate location to recover the dispenser. An alert system 110 can be remotely wirelessly controlled by a portable transmitter 112 brought along by the dispenser owner/manager to command alert system 11- to emit a loud sound through hidden internal speaker 104 and/or speaker 68. This emitted sound, perhaps a loud klaxon horn sound, is a remotely triggerable homing annunciator signal that can help authorities find the exact location of dispenser 20, especially if it is hidden, perhaps in a warehouse containing many dispenser-sized wooden crates.

In many embodiments, products 30 may include perishables, and dispenser 20 preferably includes an environmental system 120 to monitor and maintain a desired environment within the dispenser. Relevant environmental parameters typically can include maintaining at least one of internal refrigeration temperature, and humidity. In the event of an failure within system 120, e.g., internal temperature has risen too high, humidity is out of range, system 120 can sound a warning via speaker 68 and/or speaker 104 and/or can wirelessly signal wireless system 90 to summon immediate repair assistance. If system 120 has failed due to an interruption in the AC power source to dispenser 20, it will be appreciated that internal battery 106 can also supplementary power the warning portion of system 120.

An exemplary configuration for dispenser 20 might be 72″ (183 cm) height×30″ (76 cm) wide×38″ (97 cm) deep with a weight of perhaps 770 pounds (350 kg), although other configurations could of course be used. An exemplary display screen 40 diagonal might be about 32″ (81 cm), and an exemplary chute 22 may be perhaps 11″ (28 cm) wide and about 5″ (12.7 cm) high, although other sized displays and chutes could be used. It will be appreciated that dispenser 20 occupies a relatively small footprint and may be used advantageously to provide an additional point of sale that functions as a no-employee-needed express lane in an establishment.

In FIG. 1, display 40 is depicted as an integral part of dispensing machine 20. However it would suffice if display 40 were in viewing proximity to dispensing machine 20, without requiring it to be an integral part, e.g., standalone display 40′. Thus, as indicated by 40′, in some embodiments display 40 could be a standalone display, perhaps on a table next to dispensing machine 20. Communications between a standalone display 40′ and console 20 may be via a link 82, which may be a cable, or wireless, e.g., WiFi, Bluetooth, etc. In some instances a user may wish to make an order with a human clerk or teller at the store or other premises where dispenser 20 is located. The clerk can demonstrate use of the system on a remote display 40′, possibly a display on a tablet, perhaps at a counter area in the store, where the dispenser is located in a more secure area of the store, perhaps behind a guarded door. The user's order can be entered by the teller using the remote display 40′, the customer can pay for the order and the clerk can create and hand the customer a coupon card 52″′, which can contain a PIN, perhaps in two-dimensional or three-dimensional barcode. The coupon card when inserted by the customer into card reader 52 will inform computer system 70 that a transaction has been paid for the products represented by the PIN. Upon reading the coupon card, dispenser 20 will dispense the selected and paid for products via chute 22. Alternatively, if the PIN is created on paper, the user can be instructed by the clerk to hold the printed PIN before camera 64′, which will read the PIN, and in like manner cause the selected and paid for products to be dispensed. An advantage of this type of clerk-assisted sale is that the clerk may be located in a relatively low security region of a store, whereas the dispenser may be disposed in a higher security region of the store. The ministerial acts of selecting and paying for the products are carried out in the low security region whereas access to and receipt of the selected and paid for products is carried out in the higher security region of the store. But for the teller assistance, it is possible no sale would have occurred for this particular customer. Note too that if the user wished to defer pickup of the selected and paid for products, the user can defer presenting the coupon card or PIN until a later date, in which case dispenser 20 performs a virtual locker function or digital cart function for this user.

As described later with respect to FIG. 7, the display may in fact be on a smart device, located quite remotely (although not necessarily) from dispenser 20, with communications between the smart device and dispenser 20 being via a wireless link 42′. In such embodiments the user may choose to select products 30 from an interactable menu that is displayed on the smart device. A qualified user can then pay for the selected products using the smart device, e.g., authorizing payment from a credit card or other account, and can pick-up the selected and paid for products later. In such embodiments, dispenser 20 acts much like a locker for the user.

Dispensing machine 20 further includes an internal computer system 70 that typically includes a processor 72, memory 74, software routines 76 stored in memory 74 and executable by processor 72 to govern information displayed on menu 42, among other tasks, including monitoring inventory, security and payment, and dispenser protection operations. Computer system 70 preferably further includes an input/output system 78 that communicates via link 80 (e.g., a cable, a wireless link such as WiFi) with system 90 and inventory-databank system 92 that may be located remotely from dispenser 20, perhaps in the cloud. In embodiments where products 30 are perishable, it is understood that dispensing machine 20 may include internal systems (not shown) to regulate temperature and/or humidity as required. Without limitation, products purchasable and dispensable from dispenser 20 may include foodstuffs ingestible by humans, combustibles that humans can smoke, medicinal products, products purchasable only by adults, e.g., cannabis where legal, as well as products available to humans only upon medical prescription, e.g., medicinal cannabis. Computer system 70 will know the expiration date on each product 30 within dispenser 20. If the expiration date for a specific product is approaching, software 86 may include a routine to reduce the sales price of such product(s), to help ensure they sell before the expiration date.

Computer system 70 can track whether certain sub-display 42-22 locations on menu 42 seem to promote more sales than other locations, e.g., perhaps sub-displays located in the uppermost row. Computer system 70 knows in realtime the expiration dates of any time-critical products 30 within dispenser 20. A software routine, e.g., part of software 76, stored in memory 72 can analyze such data, and products approaching their expiration dates can be displayed and advertised in the most favorable menu sub-display 42-22 locations, perhaps first row, first column, to help ensure the product sells before the expiration date. As such, dispenser 20 acts intelligently to promote sales of the products 30 within, to maximize sales and profits to the owner or manager of dispenser 20, and to timely expedite sales to users. Further, if desired computer system 70 can cause time-of-day and/or day-of-week discounts to be displayed, to help sell products 30. Since computer system 70 knows the date of birth of each user, if desired, computer system 70 can create a programmable point of sale message, perhaps “Happy Birthday” discounts, e.g., 42-9 in FIG. 1, if a user makes purchases within a few days of the relevant birthday. Note too that since computer system 70 knows the user's identity and knows the user's past purchase history, products routinely purchased by this user may dynamically be caused to appear in a more prominent region of tiered menu 40, or appear graphically highlighted or perhaps blinking, or enumerated, e.g., text 42-9′ perhaps saying “you usually like to buy these products etc.” in FIG. 1. In short, system 10 can intelligently customize and tailor the appearance of tiered menu 42 contents to accommodate the known purchasing habits of this user. Such customization, be it in terms of optimizing menu location of customer past favorite products, and/or presenting customized text, can help the user make faster selections, and can help the owner or manager of dispenser 20 optimize profits. In areas where electrical power may be expensive, computer system 70 can facilitate sales during times of non-peak energy consumption, while minimizing sales otherwise. Of course normal advertising would alert potential users to such curtailed operation during times of peak energy consumption.

Preferably computer system 70 and inventory-databank 92 work together to enable product inventory data at the site location of dispenser 20 to be decremented and thus tracked in realtime as products are sold and dispensed. Further, the contents displayed on menu 42 can be dynamically modified at any time by computer system 70. For example, if there is no more inventory for a specific product or product size, menu 42 will stop displaying information relating to such product until product inventory within dispenser 20 is replenished. If there is a sudden price change for a product, the change can be displayed in realtime on menu 42. Such realtime accuracy in information displayed on menu 42 contributes to user goodwill in that time is not wasted selecting products that are already sold-out. In some embodiments, displayed items that the user examined but did not purchase after reading further details can be tracked by computer system 70. Such tracking can provide insight to the manager or owner of dispensing machine 20 as to which unpurchased products may be more potentially interesting than other products. Possibly such interesting but unpurchased products should have a more attractive photograph in menu 42, perhaps a slightly lower price, or perhaps a more favorable sub-display 42-22 location. Further, as noted, since computer system 70 knows what products 30 within dispenser 20 have relatively imminent expiration sales dates, such products can be displayed with reduced prices, to enhance likelihood of sale before the expiration date. Such marketing type data is readily available to overall dispensing system 10 and computer system 70. By contrast, if such products were dispensed by a clerk behind a counter to the user, there might be no realtime insight or awareness of such potential marketing data. Other marketing correlations of potential interest that can be generated automatically by dispensing system can include without limitation actual sales of selected products versus days of the week, versus time of day, versus large or small product photo, versus sub-display location in the displayed menu. Further, while the menu display shown in FIG. 1 is displayed in English, it is understand that a menu option providing choice of different languages may be included.

Assume user 32 interacts with dispenser 20 in FIG. 1 by touching menu display 42 with a finger. For example, display area 42-2 may set out Terms of Use that perhaps recites terms to protect the owner of dispenser 20. Such terms may include explicit acknowledgement that the user is of legal age, and is a person qualified and authorized to use the dispenser. In some jurisdictions, there may be legal requirements for explicit language in the Terms of Use. In the embodiment of FIG. 1, the user by pressing the Touch to Start region of area 42-2 acknowledges having read and agreed to the Terms, and causes menu 42 to progress to a next, second, menu tier.

FIG. 2 depicts an exemplary next, or second, menu tier 42 on display screen 40. Changes in the displayed content of menu 42 as seen on display screen 40 are governed by computer system 70 responsive to sensed user location touching on the display screen. Menu 42 now shows an array 42-4 of sub-displays 42-4 (here arranged in an exemplary five rows and four columns), presenting twenty products that may be of interest to the user. It is understood that more or fewer than twenty products may be presented, and that menus need not present products in an array matrix format as shown. The array of products in the second menu tier may be larger than is conveniently viewable at one time on the display screen. Accordingly, scroll arrows 42-6 (shown near bottom of display) allow the user to scroll through additional rows of sub-displays not presently displayed. If a product of interest is still not found, user touching region 42-8 (SEE MORE PRODUCTS) will bring up a next, e.g., third, tier of displayed menu products.

Still referring to FIG. 2, user touching the “See More Products” area 42-8 causes a new array of sub-displays of different products to be displayed, under control of computer system 70. If this further menu display tier presents nothing of interest, the user can again press icon 42-8 to bring up a further menu tier with another array of products. This progression through the menu tier can continue until all available products have been presented on the menu display. The second and subsequent menu tiers offer a “BACK” icon 42-10 to enable the user to review a previously displayed menu tier.

In FIG. 2, each sub-display includes an image 42-12, preferably a good resolution photograph or a video clip, of a product, with accompanying brief text 42-14, perhaps stating the product name and size. Each sub-display preferably includes an area 42-16 stating unit price, although unit price could be included with text 42-14. In FIG. 2, product photographs 42-12 are depicted iconographically for ease of illustration. If desired the product photograph 42-12 could fill the entire sub-display 42-22, with explanatory text 42-12 superimposed.

Preferably dispenser 20 is ADA compliant. For example, ADA handicapped icon 42-18 at the display screen bottom if touched by the user compresses the vertical height of the displayed menu 42 to the bottom 25% or so of the size of display screen 40. This would enable a user sitting in a wheelchair to reach and touch an image in a sub-display in the uppermost row of array 42-4. A HELP icon 42-6 is available should a problem or question arise. For visually impaired users, audible cues may be emitted by speaker 68. Further, in some embodiments a user's touch of a sub-display area 42-22 can cause a vocalized description of what is shown to be annunciated from speaker 68, to aid visually impaired users.

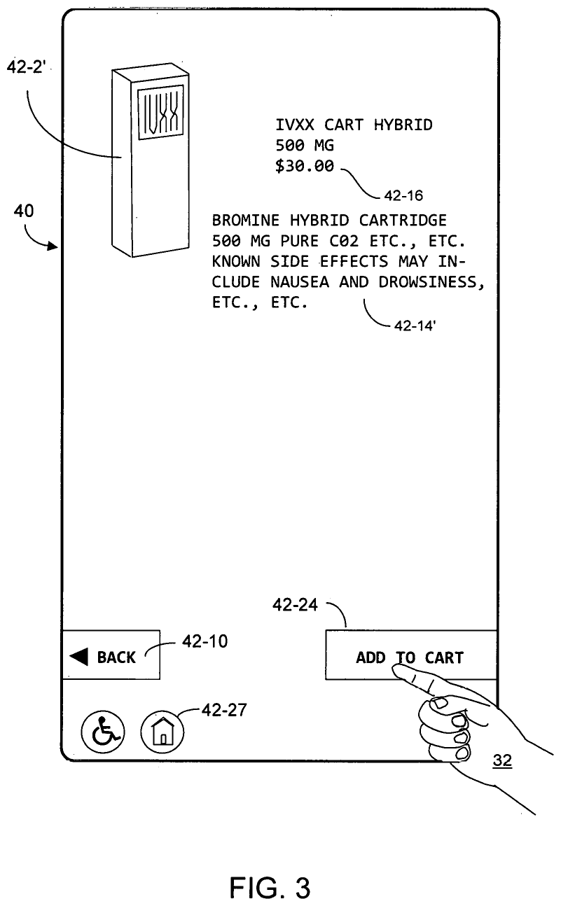

Assume that user 32 looking at menu 42 displayed in FIG. 2 wishes to learn more about the product in the sub-display 42-22, at the third row, third column of the display array 42-4. The user can touch sub-display 40-22 displaying the product image, as shown in FIG. 2, whereupon display screen 40 will advance and present what is depicted in FIG. 3.

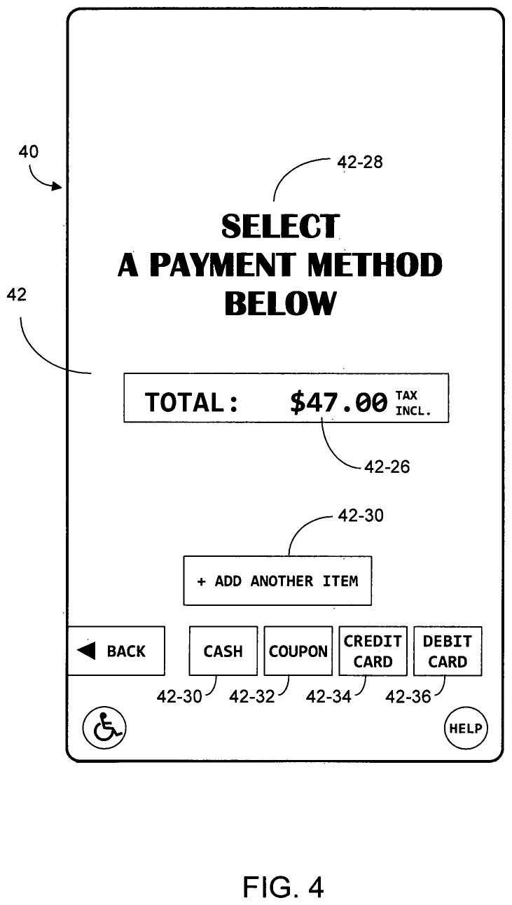

In FIG. 3, an enlarged photograph or image 42-2′ of the selected product of interest appears, with the previously displayed price 42-4. However now there is more room to present a more detailed text description 42-16″ of the selected product, potential benefits, potential side effects, etc. If the user wishes tentatively to purchase this product, the user simply touches the “Add to Cart” icon 42-24. Computer system 70 will then advance to the next menu tier, as shown in FIG. 4. If however the user does not wish to purchase this product, the user can simply touch the BACK icon 42-10 to revert to the preceding menu tier, as shown in FIG. 2. The user can also press the “Home” icon 42-27 to revert the menu to the very first tier or home screen shown in FIG. 1. It is understood that other menu sequences could instead be implemented by computer system 70.

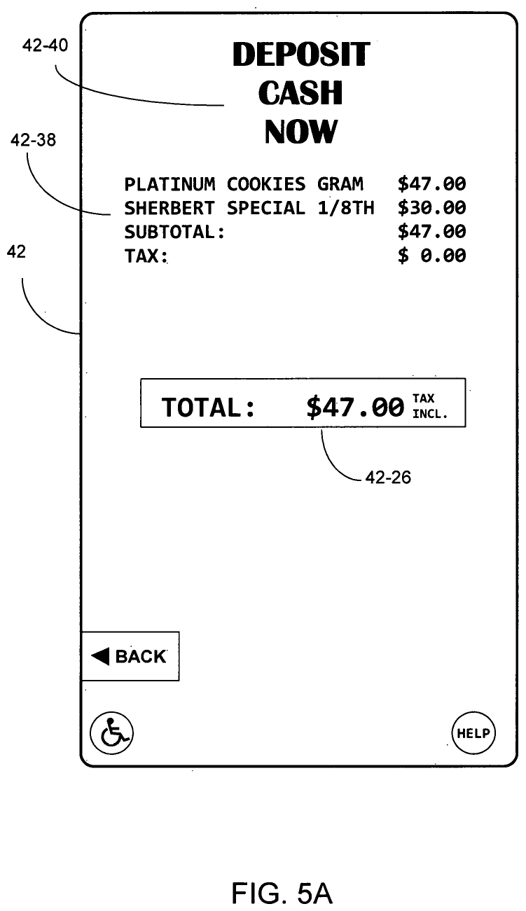

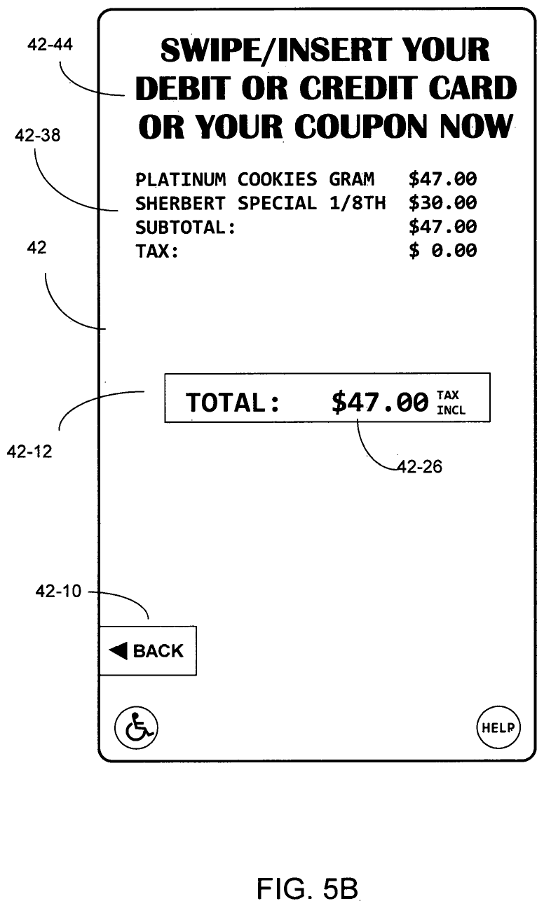

In FIG. 3, assume that the user presses “Back” icon 42-10, and selects another product (or products), either from the menu tier displayed in FIG. 2, or from further menu tiers (not shown). The user would then be invited to press the “Add to Cart” icon 42-24 with respect to the additional product(s) selected. At this juncture the menu tier would appear as shown in FIG. 4, again under command of computer system 70. The user has great flexibility and may select and thus add one of multiple quantities of some or many products 30 displayed on menu 40. After payment is confirmed, described with respect to FIG. 4A, FIG. 4B, and FIG. 5, all of the purchased products are dispensed from chute 22.

As shown FIG. 4, the total dollar amount of the product(s) thus far selected is displayed 42-26 on menu 42, and text 42-30 invites the user to “Add Another Item”. The user can instead press the “BACK” icon to revert to the previous menu tier. If the user is satisfied with the present selection, text 42-28 invites the user to select a method of payment. The user can select from and press “CASH” icon 42-30, or “COUPON” 42-32, OR “CREDIT CARD” icon 42-34, OR “debit card” ICON 42-36 to make payment for the selected products. As noted elsewhere herein, the owner or manager of dispenser 42 may issue a Coupon bearing a dollar amount to a user, perhaps as change on a previous transaction, perhaps as a reward for referring other users, etc.

FIG. 5A depicts the next menu tier 42 displayed if cash payment (icon 42-30) was selected by the user in FIG. 4. Text 42-38 recapitulates the number and names of products selected for purchase, and text 42-26 recites the total purchase cost. Text 42-40 directs the user to deposit cash to make the purchase, which cash 50′ will be inserted into cash reader 50 on dispenser 20. After the cash has been inserted, confirmed as genuine, and counted by cash reader 50, the selected and paid-for products are dispensed to the user from chute 22 (see FIG. 1). At this juncture the menu display reverts to the Home menu, as shown in FIG. 1.

FIG. 5B depicts the next menu tier 42 displayed if payment by coupon (icon 42-32), by credit card (icon 42-34), or debit card (icon 42-36) was selected in FIG. 4. FIG. 5B is similar to FIG. 5A except now the user is directed by text 42-144 to swipe or insert the user's debit card (52′) or credit card (52″) or coupon card (52″), see FIG. 1, using card reader 52 in FIG. 1. If the debit or credit or coupon card has an internal IC chip, the user will insert the card into card reader 52. Otherwise, the user will swipe the card using card reader 50. Assuming computer system 70 communicates with the relevant credit or banking agency (for credit or debit card) or with the owner of dispenser 20 (for a coupon), and confirms validity of the relevant card, the transaction proceeds. The user's relevant account is debited, if a coupon was used and there is change, the user can be asked by a menu display whether change should be cash or a coupon. If a coupon, the revised or replacement coupon is removed from card reader 50, and the now paid for selected products are dispensed to the user from chute 22 (see FIG. 1). It is understood that multiple products, including multiple quantities, can be dispensed in a single transaction from dispenser 20.

At this juncture, the menu display reverts to what was shown in FIG. 1. If dispenser 20 includes a near field communication reader system 54 (see FIG. 1), in FIG. 5B, menu 42 can include text offering that mode of payment, and prompting the user to bring the user's smartphone or smart device in proximity to the dispenser. Again, once payment is made and confirmed, the selected and paid for products are dispensed out of chute 70 to the user. Regardless of mode of payment, the user can access a permanent record of this (and previous transactions) by visiting the user's account with the owner or manager of dispenser 20 online, at the relevant, secure, website.

After the selected products have been paid for and dispensed, computer system 70 communicates with system 90 (and possibly linked systems such as 90′, 90″) to decrement inventory at the site of dispenser 20 by the quantity of products sold and dispensed. System 90 can at any time update inventory to be displayed on menu 42. Such dynamic and realtime updates occur whenever there is a product price change, or inventory on a product drops to zero (in which case no menu display of that product is to occur). If desired, a “temporary out of stock” sign can be displayed in lieu of the normal text for that product. System 10 via computer system 70 and system 90 can alert staff in the building where dispenser 20 is located to restock, especially if the just sold out product is a best seller. Restocking dispenser 20 entirely to fill empty hoppers within with products may take perhaps 15 minutes, and if desired an automatic restocking mechanism could perhaps be implemented. Once a sold-out product has been restocked in dispenser 20, inventory system 92 is appraised, the product image and related text is again displayed in the tiered menu. Such updates occur whenever required by price or product inventory change, and computer system 70 preferably queries system 90 for any changes before progressing from the Home menu of FIG. 1, to the initial product menu tier, as shown in FIG. 2. It is understood that the owner or manager of dispenser 20 can communicate with system 90, e.g., with an external computing system (not shown), to input such changes and to note inventory depletion to order inventory for restocking dispenser 20. The owner or manager can also access system 90 remotely, e.g., via a secure internet web link on a 24/7 basis. As such, system 70 and system 90, 90′, 90″ can provide a fully integrated remote management system with full integrated sales and product accounting features.

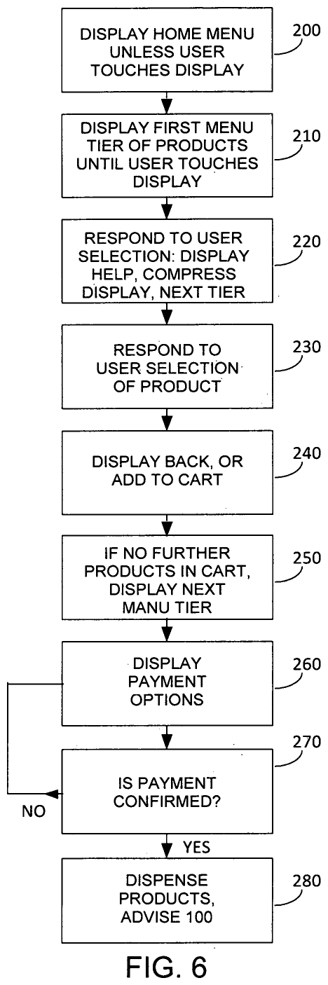

FIG. 6 is a simplified flow diagram depicting exemplary method steps carried out by dispensing machine 20 computer system 70, working in cooperation with system-90. The method steps depicted in FIG. 6 preferably are carried out by computer system 70 in dispenser 20, typically in cooperation with system-database 92, which is typically situated external to dispensing machine 20. As noted processor 72 executes software, e.g. 76, stored in memory 74 to detect and process user interaction with displayed menu 42, among other tasks. It is understood that before gaining access to system 10, the user will have demonstrated qualification to access dispenser 10, including men us that are displayable by said system. As noted earlier, the user may have been issued an ID card by the owner or managers of system 10 after proving entitlement to purchase products that may be controlled substances, or may have age or quantity restrictions. Assuming the requisite authority to use system 10 has been satisfied, the user will view a display 40 such as shown in FIG. 1.

At method step 200, display 40 presents a Home menu 42, as shown in FIG. 1, which invites the user to touch the display to begin the product viewing and selection process. At method step 210, user interaction with the Home menu causes processor 72 and software 76 to display a second menu tier, e.g., an array of products such as depicted in FIG. 2. As noted, the second menu tier provides the user with several options, including touching an image of a product of interest, to scrolling the array of displayed products, to invoking a Handicapped vertically compressed display, to invoking Help. In response to user-touching of a relevant icon or portion of touch-sensitive display 40, a next menu tier is invoked and displayed on dispenser 20 by computer system 70. As noted, each product displayed in the array shown in menu 42 in FIG. 2 is known by inventory-database 92 to be in stock, at the currently displayed price. This information is communicated to computer system 70 via link 80 in realtime. Consequently, every product displayed in FIG. 2 will be in stock within dispenser 20 at the currently displayed price. Any price changes will always be reflected in what is displayed in menu 42 in FIG. 2. Further, an out-of-stock product will not be included in the displayed product array of FIG. 2.

At method step 230, a next menu tier is displayed on dispenser 20, depending on what area of menu 42 in FIG. 2 was interacted with by the user. FIG. 3 shows a next menu tier 42, assuming that the user interacted by touching a product displayed in the array of products in FIG. 2.

Method step 240 in FIG. 6 represents computer system 70 response to the display of menu 42 in FIG. 3. As shown in FIG. 3, icons are presented on menu 42 enabling exemplary user responses such as “BACK”, “HOME”, “Add to Cart”. Assume at method step 240 that the user touches “Add to Cart” icon 42-24 displayed in FIG. 3.

At method step 250, assuming the user has not elected to go backwards in the menu tier, computer system 70 will display menu 42 as exemplified by FIG. 4. At this juncture, the user sees a display of the contents of the shopping cart, e.g., the total of tentative selected products, quantities, and product unit prices, and will determine the desired mode of payment by interacting with the relevant displayed menu icons, e.g., 42-30, 42-32, 42-34, 42-36. As noted, the user may interact with “BACK” icon 42-10, perhaps to add or subtract selected products to purchase.

At menu step 260, the user's selections have been made, and a mode of payment will have been selected by the user by interacting with the displayed menu. At this juncture exemplary menu displays are as shown in FIG. 5A if cash payment was selected, or as shown in FIG. 5B if payment with a credit card, debit card, or coupon card was selected.

At method step 270, the user will have inserted cash into the dispenser, or submitted a card or coupon to the dispenser, or possibly brought a smartphone in close nearfield proximity to the machine to make payment. However made, computer system 70 can count cash inserted into the dispensing machine, or communicate with relevant card or coupon providers to ensure that payment, including close field proximity payment, is bona fide. If for whatever reason payment is not accepted by computer system 70, the process can return to step 260.

If payment is correct in amount and confirmed at step 280 the selected and paid for products are dispensed to the user from chute 22. System 90 (and if present, systems such as 90′, 90″, etc.) is automatically advised of the transaction, and relevant debits to inventory for the purchased products are made. By default, once products are dispensed, the menu tier returns to the Home screen shown in FIG. 1, although other sequences could instead be implemented.

Embodiments of the present invention enable one or more users to individually access dispenser 20 remotely, perhaps from many miles distant. Briefly, a user can use a smart device, perhaps a smartphone, tablet, netbook, etc., executing a mobile app (application) executable by the smart device to access a secure website, perhaps owned or controlled by the owner or manager of system 10. Access to the secure website means the user has previously been vetted, if security so demands, for purposes of selecting and buying products 30. The app may initially display a map showing location of dispensers 20 within a desired geographic distance, e.g., 5 mile radius, 10 mile radius, etc. The user will thus first select a dispenser 20 that is relatively close to the user, for purposes of picking-up products from the dispenser. The smart device and app then enable the user to access the functional equivalent of tiered menu 40, as exemplified by FIG. 1-FIG. 5B, the display screen 142 of smart device 140. The app can via a secure website communicate remotely with system 10. As noted, depending on the nature of products 30 to be sold and dispensed, there may be legal restrictions that a potential user must satisfy before gaining access remotely to system 10. In some jurisdictions, perhaps proof of legal age and possession of a physician's medical prescription or the like might be a prerequisite to purchase of controlled products. In some instances, a would be user might be required to appear in person at a location under the control of the owners or managers of system 10 and present hard evidence to satisfy any relevant prerequisites, perhaps an original driver's license to demonstrate age and identity, perhaps an original medical prescription to demonstrate medical need for controlled products. Depending upon security requirements, the owners or managers of system 10 might verify the bona fides of a presented prescription by personally telephoning the physician's office to confirm. Once relevant prerequisites have been satisfied, the owners or managers of system 10 may issue an ID card such as 62′ to the user. The ID card typically may include any or all of a photograph of the user's face, user name and age, address, a fingerprint, a recorded vein print, a voice file of the user's stating perhaps, “my name is Frederic Jones”. The card will bear a unique PIN-type number, personal to this user, perhaps expressed as a two or three dimensional barcode. The user will be given a username and will create a password for purposes of logging on with a mobile app executed on a smart device to the owner or manager of system 10's associated website.

Consider now FIG. 7, which depicts overall system 10, which includes an electronic smart device 140 that is networkably connectable to at least one dispenser 20, 20′, preferably conveniently close to user 32′. In FIG. 7, user 32′, who has executed a relevant mobile app 130 on electronic smart device 140, which preferably has a user-interactable high definition color touch screen display 142 whereon an associated user-interactable tiered menu 144 is presented. Smart device 140 also includes an internal processor system 146 that will include, software including app 130 other software, and an I/O system 148 that typically includes WiFi, Bluetooth, and perhaps near field communication capability. Preferably menu 144 functions similarly to menu 42 on dispenser 20. Menu 144 in FIG. 7 is depicted somewhat as a composite, in that some text 150, some selection buttons 152, a sale-complete confirmation ID PIN 54 may appear on separate menu displays from pictures 146 of arrayed products on smart device 140. Similar to what was earlier described with respect to menu 42, user 32′ can touch-interact, scroll, and otherwise respond to product images 146 and/or text 150 and/or icon buttons or symbols 152 to look at various products 30 available for dispensing from dispenser 20. As noted, since system 10 and preferably distributed computing system 70, 90, etc. know the user identity, what is displayed on smart device 140 can be intelligently customized to the user. As such, a remotely located user can replicate nearly all of the experience of a user at the site of dispenser 20 in FIG. 1. (Obviously dispenser 20 options such as “insert cash” will not appear on the display screen of the remotely situation smart device.)

It is understood that prior to being allowed to use app 130 to interact typically via WiFi linkage 80′ to cloud 95 and thus, functionally, to remotely disposed system 10, and optionally systems 90′, 90″, user 32′ will have securely (e.g., using SSL) logged in with user name and password to the relevant website. Without limitation, smart device 140 may be a smartphone, tablet, netbook, notebook, PC, PDA, or smartwatch. It will be appreciated that user 32′ may use smart device 140 almost anywhere, perhaps from the comfort of home or office, which may be quite remote for the location of a dispenser 20. Thus, there is no requirement that smart device 140 be disposed in close proximity to a dispenser. The website typically may include a map or address listing, showing location of conveniently located dispensers 20, 20′, etc., which are networkably coupleable to smart device 140. Displayed dispensers such as 20, 20′ are conveniently located in the sense that it will be relatively easy for user 32′ to visit the actual selected dispenser to pick-up selected and paid for products 30 from the dispenser.

Using smart device 140 and mobile app 130, the user can examine various tiered menu pages, similar to what was displayed in FIG. 1 and FIG. 2 and select products of interest to purchase. Eventually the smart device display will present a menu similar to what was shown in FIG. 4, and the user can elect to make payment, with the understanding that a remote cash payment option will not be displayed. Rather than insert or swipe a credit or debit card or a coupon, the user can input to smart device 140 the relevant card account number or coupon number for payment. This information is conveyed from smart device 140 to cloud 95 and thence to system 10, and optionally systems 90′, 90″, which may include one or more server systems. Inventory control system 92 (see FIG. 1) is appraised of the transaction and can highlight as sold but not yet removed from dispenser to the products that were just selected and purchased. Assuming there are adequate funds behind the user's credit or debit card account or coupon, the selected products are confirmed as paid for. Smart device 140 may then display a just-generated sale complete confirmation PIN 154, which the user may wish to capture as a screen image for later use with dispenser 22, PIN reader or imager 64′ (see FIG. 1). PIN 154, which may be represented as a multi-dimensional barcode or otherwise, is a unique encapsulation of the just-completed and paid for transaction. Embedded in PIN 154 will be the user's identity, purchase date and time, and quantity and type of products purchased.

As this juncture, products 30 remain within dispenser 20, which acts as a virtual locker until the user retrieves the products from the dispenser. At a later time, perhaps hours or days or more later, user 32′ will go to the store or other location of vending machine 20. Depending upon the access security requirements for products 30 within the dispenser, user 32′ may have to first identify himself to the owner or manager of the dispenser as a qualified user. This can be done by the user's producing his user ID card, which can include a photograph of the user for comparison by a representative of the owner or manager of the dispenser. Assuming qualification passes muster, the user is given access to dispenser 20 where he can present his PIN 154 to the dispenser, e.g., by allowing camera 64′ (see FIG. 1) to capture an image of PIN 154, or inputting via key pad 44. At this juncture, dispenser 20 will output the previously selected and paid for products 30, via chute 22 for retrieval by the user. In other facilities, rather than have a representative of the owner or manager of the dispenser vet the user's bona fides as a qualified user to dispenser 20, the user can go straight to the dispenser but must first input his ID card 62′ into ID card reader 62. Depending upon level of security imposed, camera 64 can capture and system 10 can compare the facial image on card 62′ with the just capture image of the user. If there is no discrepancy, menu 42 can prompt the user to input his PIN 154 data. Once the user inputs his PIN 154 data, the previously selected and paid for products 30 are output via chute 22 to the user. As soon as products 30 are dispensed, relevant inventory data in system 92 is updated.

Thus, embodiments have been described in which associated tiered menu 42 is displayed and accessed at the site of dispensing machine 20 as in FIG. 1, or is displayed and accessed remotely on a smart device as in FIG. 7. In either embodiment, the overall system enables a qualified purchaser to self-serve in examining tiered menus showing products of interest, and to self-serve in making payment. Such manner of product selection and payment and dispensing does not require time by employees of the manager or owner of dispensing system 20, and may be made in a more leisurely and more private fashion than if ordered in person. For example, no check-out personnel are needed, and no waiting in checkout lines occurs. Also, if dispenser 20 is disposed in a secure setting so as to be available to qualified users on a 24/7 basis, user convenience is promoted, as are sales. Further, the remote access embodiment shown in FIG. 7 allows the user to make such product selection and payment from the privacy of home or office (or elsewhere). Actual pick-up of the selected and paid-for products can be deferred to the user's schedule. In such mode, dispenser 20 acts somewhat as a virtual locker. When the user appears and presents a user ID 62′, or inputs a PIN generated earlier at the time of purchase, the various selected products 30 immediately are dispensed from chute 22 to the user.

It will be appreciated that transactions with dispenser 20 may be paid for in a variety of ways, e.g., cash, credit card, debit card, smart payment using a smart device, and credit vouchers 52″, Credit voucher card 52″ can reflect a points value reward representing a bonus reward the owner of vending machine 20 may wish to grant a loyal customer, perhaps as a gesture of thanks for past purchases. Credit voucher card 52″ may also reflect credit on a transaction, e.g., perhaps on an $18 purchase the customer paid $20 cash, via money reader 50, and has elected to receive a $2 voucher card 52″ reflecting a $2 credit, rather than $2 in cash refund.

Modifications and variations may be made to the disclosed embodiments without departing from the subject and spirit of the invention as defined by the following claims.

1. A self-serve product dispenser system, including:
a product dispenser containing products dispensable from said product dispenser responsive to a user viewing, selecting, and paying for selected said products, said product dispenser being operatively responsive, with respect to said user viewing, selecting, and paying for, absent any user interaction external to said product dispenser;
a display screen presenting a tiered user-interactable menu displaying said products contained in said product dispenser, said display screen viewable by said user;
a networked computer system, coupled to said product dispenser, including a processor, memory, and software stored in said memory and executable by said processor to at least generate said tiered user-interactable menu;
an inventory-data bank system coupled to said networked computer system to maintain realtime data including at least inventory and price for said products contained in said product dispenser, and history of purchases by each said user of said self-serve product dispenser system;
a protocol and assurance system, coupled to said networked computer system, to ensure compliance with relevant regulatory standards governing authorization to access and purchase products from said self-serve product dispenser system by each said user;
wherein upon confirmation by said self-serve product dispenser system of payment by an authorized said user, said product dispenser dispenses purchased said products to said user; and
said inventory-data bank system records each said sale, debits inventory of said product sold, and said computer system persistently stores historical data information for said sale to said user.

2. The self-serve product dispenser system of claim 1, wherein said display screen has at least one characteristic selected from a group consisting of (a) said display screen is attached to said product dispenser, (b) said display screen is disposed separate from but in proximity to said product dispenser, (c) said display screen is disposed remotely from said product dispenser, (d) said display screen is part of an external smart device operable by a user, and (e) said display screen is user touch sensitive.

3. The self-service product dispenser system of claim 1, wherein said display screen is a display on an external smart device selected from a group consisting of (a) a smart phone, (b) a tablet, (c) a netbook, (d) a laptop computer, (e) a PDA, (f) a smart watch, and (g) a computer.

4. The self-service product dispenser system of claim 1, wherein: said products include at least one product selected from a group consisting of (a) foodstuffs ingestible by humans, (b) combustibles that humans can smoke, (c) medicinal products, (d) products purchasable only by adults, (e) cannabis, (f) a product requiring a medical prescription, and (g) medicinal cannabis.

5. The self-service product dispenser system of claim 1, wherein: said networked computer system customizes for said user at least one parameter, on said tiered user-interactable menu, selected from a group consisting of (a) a personalized anniversary message if date of said user's access to said self-service product dispenser system is approximate to said user's date of birth, (b) a personalized message acknowledging at least one past referral by said user of another user to said self-service product dispenser system, (c) a past purchase history by said user from said self-service product dispenser system, (d) a reconfiguring of at least a portion of said menu repositioning images of products on said menu in positions on said display.

6. The self-service product dispenser system of claim 1, wherein: sale of any said products approaching a relevant expiration date is promoted by said tiered user-interactable menu doing at least one of (a) displaying a lowered sale price for said products, (b) graphically highlighting an image of each of said products, and (C) displaying an image of each of said products in a most prominent region of said tiered user-interactable menu.

7. The self-service product dispenser system of claim 1, further including at least one of:
a battery operable theft recovery system to enable recovery of a stolen and relocated said self-service product dispenser, including a battery operable GPS-based system disposed within said self-service product dispenser to signal a change in location of said self-service product dispenser even if said self-service product dispenser has been disconnected from its own source of operating power, whereby recovery of a stolen said self-service product dispenser is enhanced, and
a battery operable theft recovery system to enable recovery of-a stolen and relocated said self-service product dispenser, said theft recovery system including a battery operated annunciator system disposed within said self-service product dispenser to emit a remotely detectable recovery signal responsive to receipt of an externally transmitted signal, whereby recovery of a stolen said self-service product dispenser is enhanced.

8. The self-service product dispenser system of claim 1, further including:
a battery operable theft recovery system to enable recovery of a stolen and relocated said self-service product dispenser, including a battery operable GPS-based system disposed within said self-service product dispenser to signal a change in location of said self-service product dispenser even if said self-service product dispenser has been disconnected from its own source of operating power; and
a battery operable theft recovery system to enable recovery of a stolen and relocated said self-service product dispenser, said theft recovery system including a battery operated annunciator system disposed within said self-service product dispenser to emit a remotely detectable recovery signal responsive to receipt of an externally transmitted signal,
whereby recovery of a stolen said self-service product dispenser is enhanced.

9. The self-service product dispenser system of claim 1, further including:
a secure website and an executable software application, accessible only to qualified users authorized to use said self-service product dispenser system;
wherein said display screen is viewable on an external smart device able to execute said software application and to access said secure website;
wherein said secure website and executable software application enable a user of said external smart device to select a nearby said product dispenser, and to view a display similar to said display on said product dispenser;
said secure website enabling said user to view, select, and pay for products contained in said nearby product dispenser, said nearby product dispenser acting as a virtual locker holding selected and paid for products for said user until said paid for products are retrieved by said user;
said self-service product dispenser system providing said user with a unique PIN ID memorializing said sale, whereby upon visiting said nearby product dispenser and presenting said PIN ID, said product dispenser dispenses to said user said paid for products.

10. The self-service product dispenser system of claim 1, further including at least one of (a) an imaging camera to capture a facial image of said user to aid in confirming user identity, (b) a biometric sensor to aid in confirming user identity, and (c) a secure identity card issued to qualified users such that a user possessing said secure identity card can go to said product dispenser and confirm user identity and authorization by inputting said secure identity card to said product dispenser, and proceed to use said product dispenser.

11. The self-service product dispenser system of claim 1, wherein form of payment by said user includes at least one of (a) credit card payment, (b) debit card payment, (c) coupon payment, (d) payment using a credit voucher issued by said self-service product dispenser system as change for a past sale, (e) cash, (f) bitcoin, and (g) payment communicated to said product dispenser using secure near field technology.

12.-28. (canceled)

29. The self-service product dispenser system of claim 1, wherein said product dispenser is distributably networkably couplable to at least one of (a) a regional one point-of-sale system, (b) a national point-of-sale system, and (c) an external smart device.
